(19) United States
(12) Patent Application Publication
(10) Pub. No.: US 2010/0063831 A1
(43) Pub. Date: Mar. 11, 2010

(54) Visualizing revenue management trade-offs via a two-dimensional pareto curve showing measures of overall volume or share versus measures of overall profitability or adjusted revenue

(75) Inventors: Charles H. Rosa, Rochester Hills, MI (US); Jonathan H. Owen, Beverly Hills, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/208,438

(22) Filed: Sep. 11, 2008

(51) Int. Cl. G06Q 10/00

(52) U.S. Cl. 705/1

(57) ABSTRACT

A system and method for visualizing the trade-off between overall production and/or sales of a portfolio of products and a resulting aggregate contribution margin (ACM). The method includes solving an optimization model, or other suitable operation, that has an objective function that describes the ACM across a portfolio of products to determine the price, sales and production levels of the products that maximize the ACM for a particular set of constraints. The optimization model is solved for increasing aggregate sales levels for those constraints. The relationship between the aggregate sales level and the aggregate ACM is then graphed, and the optimization model is solved for different sets of constraints and increasing sales. The resulting graphs are analyzed to determine which constraints maintain sales volume while maximizing ACM, maintain ACM while maximizing sales volume, maximize ACM and maximize sales volume regardless of impact on ACM.

### BACKGROUND OF THE INVENTION

1. Field of the Invention

This invention relates generally to a system and method for visualizing revenue management trade-offs between overall volume or share versus measures of overall profitability or adjusted revenue of a portfolio of products and/or services and, more particularly, to a system and method for visualizing revenue management trade-offs between overall production and/or sales of a portfolio of products and/or services and a resulting aggregate contribution margin using two-dimensional Pareto curves.

2. Discussion of the Related Art

Businesses need to set prices, sales levels and production levels across the portfolio of goods, services or products that they sell typically in an attempt to maximize an aggregate contribution margin (ACM). In other words, a manufacturing company needs to determine how many products to manufacture, when and where to sell the products and at what price to sell the products to achieve a desirable profitability. ACM can be considered a form of profit, but more specifically accounts for the variable costs and revenue associated with sales, but not structural costs. For example, ACM counts the variable profit for each unit sold, but does not count fixed costs, such as investment in plant facilities or tooling.

Systems that provide information to help make these decisions are sometimes referred to as revenue management systems. The systems allow decision makers to analyze data and make determinations based on the information that is available. The level of ACM a business can achieve depends on its manufacturing capabilities, demand for its products in the marketplace, competition from other manufacturers of the same or similar products, marketing considerations, and various other strategic and technical business constraints. Visualizing how the optimum level of ACM varies with aggregate retail sales can help companies better understand where their business should operate, as well as help them see the impact of various business constraints on that operation.

### SUMMARY OF THE INVENTION

In accordance with the teachings of the present invention, a system and method for visualizing the trade-off between overall production and/or sales of a portfolio of products and/or services and a resulting aggregate contribution margin (ACM) are disclosed that may employ a Pareto curve where each point along the curve represents an ACM-maximizing approach to running the business at a given level of aggregate production or retail sales. The method includes solving an optimization model that has an objective function that describes the ACM across a portfolio of products. The optimization model can be used to determine the prices, sales and production levels of the products that maximize the ACM for a particular set of constraints. If one of those constraints sets the aggregate sales level, the optimization model is solved for increasing aggregate sales levels. The relationship between the aggregate sales level and the aggregate ACM is then graphed. The process is repeated for different sets of constraints, each time allowing the constraint on aggregate sales to vary. The resulting graphs are analyzed to determine which solutions maintain sales volume while maximizing ACM, maintain ACM while maximizing sales volume, maximize ACM and maximize sales and/or production irrespective of its impact on ACM.

Additional features of the present invention will become apparent from the following description and appended claims, taken in conjunction with the accompanying drawings.

### BRIEF DESCRIPTION OF THE DRAWINGS

FIG. 1 is a flow chart diagram showing a process for providing information to determine the trade-off between overall production and/or sales of a portfolio of products and a resulting aggregate contribution margin;

FIG. 2 is a graph with total sales on the horizontal axis and change in total ACM on the vertical axis that can used for comparing the relationship between aggregate sales level and aggregate ACM for a particular set of business constraints; and

FIG. 3 is a graph with total sales on the horizontal axis and change in total ACM on the vertical axis showing graph lines defining a relationship between aggregate sales level and aggregate ACM for different sets of business constraints.

### DETAILED DESCRIPTION OF THE EMBODIMENTS

The following discussion of the embodiments of the invention directed to a revenue management system and related method for visualizing and understanding the trade-off between overall production and/or sales of a portfolio of products and/or services and a resulting aggregate contribution margin is merely exemplary in nature, and is in no way intended to limit the invention or its applications or uses.

As will be discussed in detail below, the present invention provides a technique for visualizing and understanding the trade-off between overall production and/or sales of a portfolio of products and/or services and the resulting aggregate contribution margin. In one embodiment, the technique employs Pareto curves where each point on the curve represents an ACM maximizing approach to running a business at a given level of aggregate production or retail sales. The technique can have application for a company that manufactures several different types of products. Although the discussion and specific examples below talk about overall production and sales and overall profitability or aggregate contribution margin, it will appreciated by those skilled in the art that the technique of the present invention also has applications for visualizing trade-offs for market or segment share, share of capacity, utilization or capacity, retail and fleet sales, gross or net revenue, EBIT, etc.

The visualization of the trade-off between overall production and/or sales of a portfolio of products and a resulting aggregate contribution margin allows decision makers to adjust a business model to be more profitable subject to the short-term and long-term operational realities of the business that are often embodied in constraints. Four solution points that are usually of particular interest to decision makers using a revenue management system of this type include points that are volume neutral, profit neutral, ACM optimal and volume maximal when compared with a particular current solution. Thus, for example, if a business has a particular pricing, sales and production strategy that it is considering as a current solution, it is likely to be interested in better strategies that either increase the ACM relative to the current solution while sacrificing no sales, maintaining the ACM of the current solution, but at a higher level of retail sales, adjusting sales so as to achieve the highest level of ACM possible or maximizing sales and/or production regardless of its impact on ACM.

The approach employs a two-dimensional graphical depiction of aggregate sales versus ACM that helps decision makers better understand the implementations of different profit maximizing, pricing, sales and production strategies. By being able to see the different solutions and, in particular, to see how ACM varies with different levels of retail sales, a business can make better informed and more accurate decisions regarding which pricing, sales and production strategies to go to market with. By focusing the attention on, but not limiting attention to, these four types of solutions, decision makers can think clearly about where they want to operate their business, and find solutions that maintain sales rates, but at a higher level of profitability, increase sales while maintaining profitability, increase profitability regardless of whether higher or lower overall sales is achieved or increase sales regardless of its impact on ACM.

The revenue management system is generally used by a manufacturer or service provider of a large portfolio of products or services to be sold. An example of a manufacturer is a vehicle manufacturer. The system employs a process that determines the price, sales and production levels that maximize ACM across the entire portfolio for a given aggregate sales level and an arbitrary set of business constraints. The set of business constraints can include any number of suitable and desirable constraints for the particular application, such as price ladders, production capacities, price bounds, cash flow constraints, etc. Although one embodiment may employ an optimization model for this purpose, other embodiments may employ other suitable operations, such as heuristic models. Processes and models that make this analysis are known to those skilled in the art that determine and set prices for a portfolio of many products that not only compete with outside competitors, but may compete with their own products. The optimization model is solved for a number of different and generally increasing aggregate sales levels using the set of business constraints. The process then graphs out the relationship between aggregate sales level and aggregate ACM for each solution to the optimization model.

These steps are then repeated for different sets of business constraints, which may change the constraints for price and number of products in the portfolio of products, and which may affect the price and number of other products in the portfolio of products. The process then adds the resulting sets of points to the graph to provide graph lines for the optimization model solutions for each set of constraints and increasing sales levels.

The process then makes the resulting graphs available to business decision makers. The process may highlight a point corresponding to an arbitrary base case strategy, which may not correspond to an optimal solution, but rather is an arbitrary point developed by a set of decision makers. The process highlights additional points on the graph that, relative to the base case point, maintains sales volumes while maximizing ACM, maintains ACM while maximizing sales volume, maximizes ACM and maximizes sales/production.

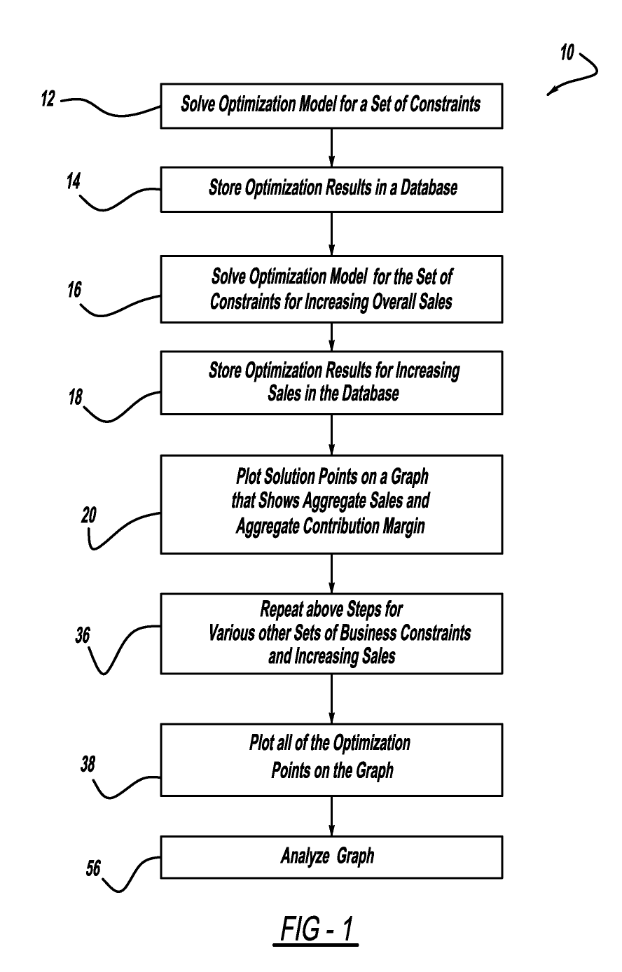

A more detailed description of the revenue management process discussed above is provided in a flow chart diagram 10 shown in FIG. 1. At box 12, the process solves an optimization model with an objective function describing the ACM achieved across a set of products and manufacturing plants. This optimization model may use a set of business constraints that limit the set of solutions that are available. Examples of business constraints for this purpose may include constraints on price ladders, production capacities, price bounds, cash flow constraints, etc. The optimization model should also be solved in the presence of an aggregate constraint that sets overall sales. The results from solving the optimization model are stored in a database at box 14.

The optimization model is then solved for increasing sales using the same set of business at box 16. In other words, the optimization model for this set of business constraints is solved, but with changes in the model that increase overall sales for all of the products. Each solution of the optimization model produces a solution corresponding to a particular aggregate sales level and a particular aggregate contribution margin. The solution of each result of the optimization problem may be saved in the database at box 18. Thus, each time the optimization model is solved for a particular set of business constraints, a data point is created where all of the data points can be combined to define a graph line that represents total sales versus ACM, as discussed below.

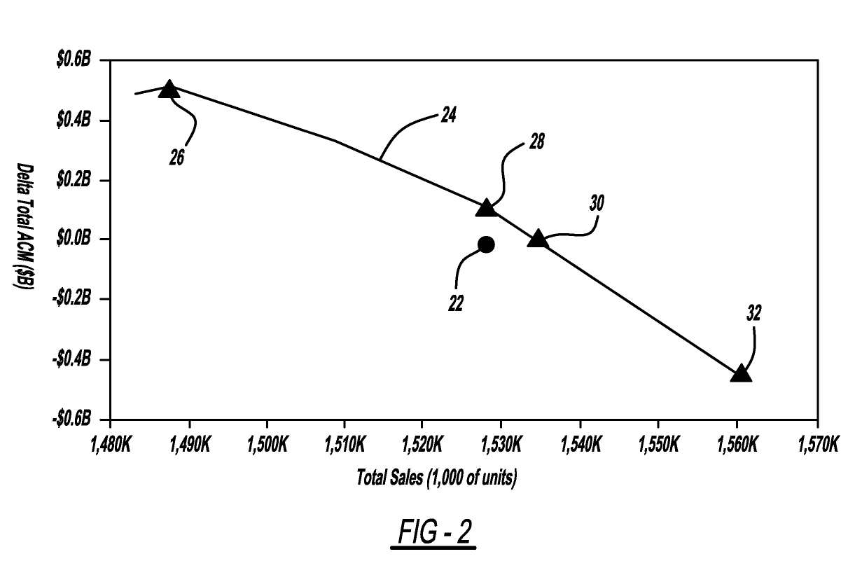

The solution points of the optimization model are plotted on a graph at box 20 that shows aggregate sales on the horizontal axis and aggregate contribution margin on the vertical axis, such as shown in FIG. 2. The graph of FIG. 2 identifies a base case point 22 that is an arbitrary point determined by experienced decision makers against which the solutions to the optimization model can be compared. The solution of the optimization model for the particular set of constraints for each change in the overall sales represents a point on the graph. Those points define a line, here line 24, for these solutions. The set of constraints for the graph line 24 represents a ±5% relaxation of sales for each product relative to the base case point 22. Point 26 represents a strategy that maximizes ACM, point 28 represents a strategy that preserves sales volume while increasing ACM, point 30 is a solution that provides a price, sales and production strategy that maintains ACM, but with higher sales volume, and point 32 represents a strategy that maximizes sales.

The solutions to the optimization model in this example represent the entire portfolio of products, and the total sales represent the total sales of all of the products in the portfolio. However, this is merely by way of example in that the total sales can be limited to any geographic area of interest. Further, the ACM on the vertical axis is for a fixed time frame in this example. However, when changing the set of constraints, the time frame can also be changed so as to look at profitability for different periods of time.

As mentioned above, FIG. 2 shows aggregate sales versus aggregate contribution margin. In other embodiments, the analysis and resulting graph may identify any change in revenue and any suitable volume, such as sales, production, etc.

The steps at boxes 12-20 are then repeated for different sets of business constraints at box 36 where the business constraints may be of the type discussed above, but are not limited to those specific examples. Particularly, the optimization model is solved for each different set of business constraints at each point of increasing sales. All of the subsequent solutions of the optimization model produce points, i.e., sets of pricing, sales and production decisions, that comprise a particular strategy, each of which has an associated aggregate sales level and contribution margin. For example, the relaxation from the base set of constraints can be changed to ±10% of sales, the number of sales of a particular product can be increased or reduced, the desired level of profitability can be changed, etc. relative to the base case to provide additional graph lines that are compared to each other and the graph line 24.

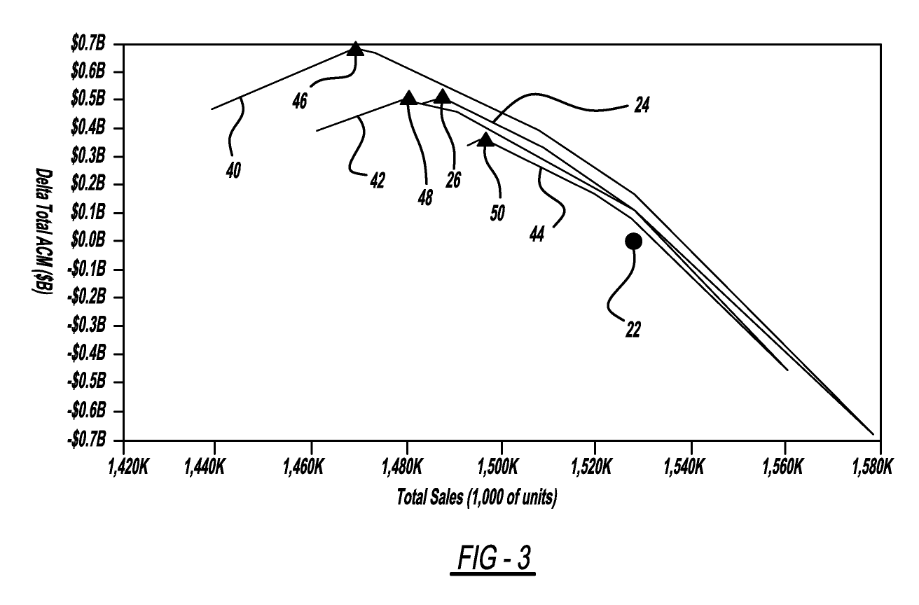

Each time the steps at boxes 12-20 are repeated and the set of constraints is changed at the box 36, a new graph line is plotted at box 38. FIG. 3 is another graph with total sales on the horizontal axis and change in total ACM on the vertical axis showing three additional graph lines 40, 42 and 44 in addition to the graph line 24 relative to the base case at the point 22, where the set of business constraints has been changed for the optimization model. For example, graph line 40 can be the base case with certain product constraints, graph line 42 can be the base case with a ±10% relaxation of each products sales and graph line 44 can be the base case with the certain product constraints and the ±5% relaxation of each products sales. Points 46, 48 and 50 are the maximum ACM points for the graph lines 40, 42 and 44, respectively. Each graph line contains points that maximize ACM, maintain volume with increased ACM, or maintain ACM with increased volume, all relative to the base case. Solutions that maximize sales/production regardless of impact on ACM, while not highlighted in FIG. 3, may also be of interest to some decision makers.

At box 50, decision analysis determines pricing, sales and production strategy. This strategy might be the result of an optimization run. It could also be an arbitrary strategy derived using non-mathematical techniques that is based on expert business judgment.

The strategies shown on the graph in FIG. 3, relative to the base case at the point 22, maintain sales volumes while increasing ACM, maintain ACM while increasing sales volumes, or maximize ACM. All of these points should be highlighted for special consideration by business analysis. Of course, all of the points should be made visible so that they may be considered by the decision makers. In particular, some decision makers may be interested in solutions that maximize sales/production irrespective of its impact on ACM.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing revenue management that considers sales volume and profitability, said method comprising:
providing an optimization model for describing adjusted revenue for a plurality of products and/or services;
solving the optimization model using a set of business constraints for different sales volumes of the products and/or services, where each solution of the optimization model corresponds to a particular sales volume level and a particular adjusted revenue;
plotting the solutions to the optimization model on a graph that shows sales volume and adjusted revenue;
repeating the steps of solving the optimization model and plotting the solutions of the functions on the graph using different sets of constraints; and
analyzing the graph.

2. The method according to claim 1 wherein the business constraints include one or more of price ladders, production capacities, price bounds and cash flow constraints.

3. The method according to claim 1 wherein the business constraints include a relaxation of sales of individual products and/or services.

4. The method according to claim 1 wherein the graph lines are compared to an arbitrary base case condition.

5. The method according to claim 1 wherein the adjusted revenue is an aggregate contribution margin.

6. The method according to claim 5 wherein the graph for each set of solutions for the optimization model indicates a point that maximizes the aggregate contribution margin, a point that preserves sales volume while increasing the aggregate contribution margin, a point that maintains aggregate contribution margin but increases sales volume and a point that maximizes sales volume.

7. The method according to claim 5 wherein analyzing the graph includes analyzing the differences between the graph lines to determine conditions that maintain sales volumes while maximizing aggregate contribution margin, maintain aggregate contribution margin while maximizing sales volume, maximizes aggregate contribution margin and maximizes sales volume regardless of impact on aggregate contribution margin.

8. The method according to claim 1 wherein analyzing the graph includes analyzing the graph using non-mathematical techniques.

9. A method for providing revenue management that considers sales volume and profitability, said method comprising:
providing an optimization model for a portfolio of products and/or services that can be used to find prices, sales and production levels of the products that maximize an aggregate contribution margin for the products and/or services that are embodied in an objection function for the optimization model;
solving the optimization model that contains a set of business constraints for different sales of the products and/or services where each solution to the optimization model corresponds to a particular aggregate sales level and a particular aggregate contribution margin;
plotting the solutions of the optimization model on a graph that shows aggregate sales and aggregate contribution margin;
repeating the steps of solving the optimization model and plotting the solutions of the model on the graph using different sets of constraints; and
analyzing the graph to determine price and production levels of the products and/or services that maintain sales volumes while maximizing aggregate contribution margin, maintain aggregate contribution margin while maximizing sales volume, maximizes aggregate contribution and maximizes sales volume regardless of impact on aggregate contribution margin;

10. The method according to claim 9 wherein the business constraints include one or more of price ladders, production capacities, price bounds and cash flow constraints.

11. The method according to claim 9 wherein the business constraints include a relaxation of sales of individual products and/or services.

12. The method according to claim 9 wherein the graph lines are compared to an arbitrary base case condition.

13. The method according to claim 9 wherein the objective function for the optimization model describes the relationship between prices, sales, production and aggregate contribution margin.

14. The method according to claim 9 wherein analyzing the graph includes analyzing the graph using non-mathematical techniques.

15. The method according to claim 9 wherein the products are vehicles including vehicles of different models.

16. A method for providing revenue management that considers sales volume and profitability, said method comprising:
providing an optimization model with an objective function for describing an aggregate contribution margin for a plurality of products;
solving the optimization model using a set of business constraints for increasing sales of the products, where each solution of the optimization model corresponds to a particular aggregate sales level and a particular aggregate contribution margin;
plotting the solutions to the optimization model on a graph that shows aggregate sales and aggregate contribution margin;
repeating the steps of solving the optimization model and plotting the solutions of the functions on the graph using different sets of constraints;
defining an arbitrary base case condition on the graph; and
analyzing the graph by comparing the graph lines to each other and the base case condition to determine price and production levels of the products that maintain sales volumes while maximizing aggregate contribution margin, maintain aggregate contribution margin while maximizing sales volume, maximizes aggregate contribution margin and maximizes sales volume regardless of impact on aggregate contribution margin.

17. The method according to claim 16 wherein the business constraints include one or more of price ladders, production capacities, price bounds and cash flow constraints.

18. The method according to claim 16 wherein the business constraints include a relaxation of sales of individual products.

19. The method according to claim 16 wherein analyzing the graph includes analyzing the graph using non-mathematical techniques.

20. The method according to claim 16 wherein the products are vehicles including vehicles of different models.
